(19) United States
(12) Patent Application Publication
(10) Pub. No.: US 2015/0134181 A1
(43) Pub. Date: May 14, 2015

(54) POSITION ESTIMATION AND VEHICLE CONTROL IN AUTONOMOUS MULTI-VEHICLE CONVOYS

(71) Applicant: NEYA SYSTEMS, LLC, Wexford, PA (US)

(72) Inventor: Mark Daniel Ollis, Freedom, PA (US)

(21) Appl. No.: 14/581,363

(22) Filed: Dec. 23, 2014

Related U.S. Application Data
(62) Division of application No. 14/160,524, filed on Jan. 21, 2014.
(60) Provisional application No. 61/812,639, filed on Apr. 16, 2013.

(51) Int. Cl. B60W 30/00; G01C 21/00

(52) U.S. Cl. CPC B60W 30/00; G01C 21/00
USPC 701/23

(57) ABSTRACT

Techniques are provided for providing position estimations in an autonomous multi-vehicle convoy. Those techniques include initializing a convoy state, selecting a next sensor reading; predicting a convoy state, updating the convoy state, and broadcasting the convoy state to vehicles in the multi-vehicle convoy.

### CROSS-REFERENCE TO RELATED APPLICATION

This application is a divisional of U.S. application Ser. No. 14/160,524, filed Jan. 21, 2014, which claims the benefit of U.S. Application No. 61/812,639, filed Apr. 16, 2013, entitled “Position Estimation And Vehicle Control In Autonomous Multi-Vehicle Convoys,” which is hereby incorporated by reference in its entirety.

### FIELD OF TECHNOLOGY

The present disclosure relates to autonomous, multi-vehicle convoy systems and, more specifically, to the use of control systems techniques to improve position estimation and vehicle control in autonomous, multi-vehicle convoy systems.

### BACKGROUND

Multi-vehicle convoys are typically employed in military applications where personnel and/or resources need to be transported over long distances. In hostile environments, convoys can provide additional protections that might not be available from single vehicles. For example, the defensive capabilities of a single vehicle may be less than the capabilities of a larger group of vehicles. However, even with the increased protections afforded by a larger number of vehicles in a convoy, such convoys can still be targets for opposing forces. Furthermore, opposing forces looking to cause the most human casualties may focus their efforts of convoys.

To reduce the threat of human casualties, work has been done to automate convoy vehicles, such as non-personnel convoys. Since convoys often travel on known roads or paths, autonomy can be employed, either to eliminate the need for a human driver or to reduce the need for the driver to pay attention. When these convoys travel on well-conditioned roads with clearly painted lines, it may be possible to use computer vision techniques to detect the painted road lines and maintain convoy vehicles on the road. However, this approach fails if the road lines are not visible, for example, due to weather conditions, obstacles, and the like, or if the lines are missing altogether. Even a patch of road missing road lines can prevent road-tracking-dependent automated convoy systems from operating properly.

To address current deficiencies, some autonomous convoy systems employ a leader-follower approach, in which, one vehicle servers as a leader that another vehicle follows. Notably, this approach minimizes control complexity, at least, generally speaking. Current leader-follower autonomy methods, however, often produce trailing vehicle trajectories unacceptably different from the lead vehicle trajectory. In military applications, such path deviation error can seriously endanger overall convoy mission success, as well as the security of each convoy vehicle, particularly in combat zones. For example, follower vehicles that stray from a desired path are more likely to encounter roadside hazards or improvised explosive devices (IEDs), which they might have avoided otherwise had they followed the lead vehicle more precisely.

Some automated convoy approaches employ a set of sensor packages that include global positioning system (GPS) and inertial sensing installed on each vehicle. However, approaches that simply follow GPS waypoints sent from the lead vehicle do not provide sufficient accuracy to maintain proper convoy movement. Moreover, these approaches rapidly degrade in the absence of good GPS signals. Some have proposed non-GPS based methods, in which each vehicle tracks and follows its predecessor without resort to waypoints. But these approaches do not scale well to longer convoys, as small tracking and control errors accumulate with each successive follower. To date, fusion of these two approaches has also failed to consistently achieve the desired accuracy for long convoys.

### SUMMARY

In accordance with an example, a computer-implemented method for providing position estimations in an autonomous multi-vehicle convoy includes initializing a convoy state, selecting a next sensor reading; predicting a convoy state, updating the convoy state, and broadcasting the convoy state.

In accordance with another example, a computer-implemented method for determining a control sequence for a follower vehicle in an autonomous multi-vehicle convoy includes receiving a lead vehicle control sequence, estimating the lead vehicle path; forward simulating a follower vehicle control sequence based on the lead vehicle control sequence, testing the simulated control sequence for convergence with the lead vehicle path, performing gradient descent on the control sequence, if the simulated control sequence does not converge with the vehicle path, and issuing the simulated control sequence to the follower vehicle, if the simulated control sequence does converge with the vehicle path.

In accordance with an example, a computer-implemented method for providing pose estimations in a multi-vehicle convoy, the method comprises: initializing, using a convoy control system, a convoy state, wherein the convoy state comprises pose data for each vehicle of the multi-vehicle convoy or pose data for a subset of the vehicles of the multi-vehicle convoy; selecting, using the convoy control system, a sensor reading data from at least one vehicle sensor amongst a plurality of vehicle sensors; updating, using the convoy control system, a future convoy state based on the sensor reading data; predicting, using the convoy control system, the convoy state to a future point in time; and communicating the updated convoy state for affecting future pose of the multi-vehicle convoy.

In accordance with an example, a vehicle of a multi-vehicle convoy, the vehicle comprises: a convoy control system having a processor, a memory and a communications interface, wherein the convoy control system configured to initialize a convoy state, wherein the convoy state comprises pose data for each vehicle of the multi-vehicle convoy or pose data for a subset of the vehicles of the multi-vehicle convoy; select a sensor reading data from at least one vehicle sensor amongst a plurality of vehicle sensors; update a future convoy state based on the sensor reading data; predict the convoy state to a future point in time; and communicate the updated convoy state for affecting future pose of the multi-vehicle convoy.

In accordance with an example, a non-transitory computer-readable storage medium having stored thereon a set of instructions, executable by a processor, for providing pose estimations in a multi-vehicle convoy, the instructions comprising: instructions for initializing, using a convoy control system, a convoy state, wherein the convoy state comprises pose data for each vehicle of the multi-vehicle convoy or pose data for a subset of the vehicles of the multi-vehicle convoy; instructions for selecting, using the convoy control system, a sensor reading data from at least one vehicle sensor amongst a plurality of vehicle sensors; instructions for updating, using the convoy control system, a future convoy state based on the sensor reading data; instructions for predicting, using the convoy control system, the convoy state to a future point in time; and instructions for communicating the updated convoy state for affecting future pose of the multi-vehicle convoy.

In accordance with an example, a computer-implemented method for determining a control sequence for a follower vehicle in a multi-vehicle convoy, the method comprising: a) receiving, at a convoy control system, a control sequence for a lead vehicle; b) estimating, at the convoy control system, a vehicle path for the lead vehicle; c) initializing a current best control sequence equal to the lead vehicle control sequence; d) forward simulating, at the convoy control system, a vehicle control sequence for the follower vehicle based on the current best vehicle control sequence, generating a forward simulated path; e) measuring the error between the forward simulated vehicle path and the lead vehicle path; f) performing a gradient descent operation on the forward simulated vehicle control sequence; g) analyzing the forward simulated vehicle control sequence for convergence with the lead vehicle path; if the forward simulated control sequence does not converge with the vehicle path, setting the current best control sequence equal to the forward simulated vehicle control sequence then repeating d), e), f) and g); and if the forward simulated control sequence does converge with the vehicle path, issuing the forward simulated control sequence to the follower vehicle.

In accordance with an example, a vehicle of a multi-vehicle convoy, the vehicle comprises: a convoy control system having a processor, a memory and a communications interface, wherein the convoy control system configured to a) receive, at a convoy control system, a control sequence for a lead vehicle; b) estimate, at the convoy control system, a vehicle path for the lead vehicle; c) initialize a current best control sequence equal to the lead vehicle control sequence; d) forward simulate, at the convoy control system, a vehicle control sequence for the follower vehicle based on the current best vehicle control sequence, generating a forward simulated path; e) measure the error between the forward simulated vehicle path and the lead vehicle path; f) perform a gradient descent operation on the forward simulated vehicle control sequence; g) analyze the forward simulated vehicle control sequence for convergence with the lead vehicle path; if the forward simulated control sequence does not converge with the vehicle path, set the current best control sequence equal to the forward simulated vehicle control sequence then repeating d), e), f) and g); and if the forward simulated control sequence does converge with the vehicle path, issue the forward simulated control sequence to the follower vehicle.

In accordance with an example, a non-transitory computer-readable storage medium having stored thereon a set of instructions, executable by a processor, for determining a control sequence for a follower vehicle in a multi-vehicle convoy, the instructions comprising: a) instructions for receiving, at a convoy control system, a control sequence for a lead vehicle; b) instructions for estimating, at the convoy control system, a vehicle path for the lead vehicle; c) instructions for initializing a current best control sequence equal to the lead vehicle control sequence; d) instructions for forward simulating, at the convoy control system, a vehicle control sequence for the follower vehicle based on the current best vehicle control sequence, generating a forward simulated path; e) instructions for measuring the error between the forward simulated vehicle path and the lead vehicle path; f) instructions for performing a gradient descent operation on the forward simulated vehicle control sequence; g) instructions for analyzing the forward simulated vehicle control sequence for convergence with the lead vehicle path; instructions for, if the forward simulated control sequence does not converge with the vehicle path, setting the current best control sequence equal to the forward simulated vehicle control sequence then repeating d), e), f) and g); and instructions for, if the forward simulated control sequence does converge with the vehicle path, issuing the forward simulated control sequence to the follower vehicle.

In accordance with an example, a computer-implemented method for determining a control sequence for a follower vehicle in a multi-vehicle convoy, the method comprising: initializing a vehicle parameter model comprising a plurality of parameters for a vehicle; obtaining log data for the vehicles whose parameters are to be learned, the log data comprising control data and actual pose data for the vehicle over a period of time; determining a vehicle model error from comparing estimated pose data and the actual pose data for the multi-vehicle convoy; and in response to determining the vehicle model error, updating the vehicle parameter model to reduce the vehicle model error.

In accordance with an example, a vehicle of a multi-vehicle convoy, the vehicle comprising: a convoy control system having a processor, a memory and a communications interface, wherein the convoy control system configured to initialize a vehicle parameter model comprising a plurality of parameters for a vehicle; obtain log data for the vehicles whose parameters are to be learned, the log data comprising control data and actual pose data for the vehicle over a period of time; determine a vehicle model error from comparing estimated pose data and the actual pose data for the multi-vehicle convoy; and in response to determining the vehicle model error, update the vehicle parameter model to reduce the vehicle model error.

In accordance with an example, a non-transitory computer-readable storage medium having stored thereon a set of instructions, executable by a processor, for determining a control sequence for a follower vehicle in a multi-vehicle convoy, the instructions comprising: instructions for initializing a vehicle parameter model comprising a plurality of parameters for a vehicle; instructions for obtaining log data for the vehicles whose parameters are to be learned, the log data comprising control data and actual pose data for the vehicle over a period of time; instructions for determining a vehicle model error from comparing estimated pose data and the actual pose data for the multi-vehicle convoy; and instructions for, in response to determining the vehicle model error, updating the vehicle parameter model to reduce the vehicle model error.

### BRIEF DESCRIPTION OF THE DRAWINGS

FIG. 1 is a high-level system block diagram of a vehicle computing system that implements position estimation and vehicle control methods for autonomous multi-vehicle convoys.

FIG. 2 illustrates a multi-vehicle convoy.

FIG. 3 illustrates a linked multi-vehicle convoy according to the present disclosure.

FIG. 4 illustrates measuring the relative position of vehicles in a multi-vehicle convoy according to the present disclosure.

FIG. 5A illustrates a process of estimating the convoy vehicles' positions according to the present disclosure.

FIG. 5B illustrates a process of estimating the time-lagged position of the lead vehicle's position according to the present disclosure.

FIG. 6 illustrates simulating a vehicle's estimated path using a lead vehicle's control sequence, according to the present disclosure.

FIG. 7 illustrates a convoy vehicle's estimated path after performing numerical optimization on a lead vehicle's control sequence according to the present disclosure.

FIG. 8 illustrates the process of determining a control sequence for a multi-vehicle convoy vehicle according to the present disclosure.

FIG. 9 illustrates an example model parameters learning algorithm.

FIG. 10 illustrates an example measured error function.

### DETAILED DESCRIPTION

The present disclosure is generally directed to improved position estimation and vehicle control in autonomous multi-vehicle convoys. Some automated convoy approaches employ a set of sensor packages that include GPS and inertial sensors installed on each vehicle. However, simply following waypoints from a lead vehicle does not provide sufficient accuracy. In other typical lead-follower convoy configurations, each vehicle may be configured to follow a vehicle directly in front of it without regard for or knowledge of the path traveled by the other vehicles. In these configurations, however, errors in position tend to propagate throughout the entire multi-vehicle convoy. Since this error is cumulative, the vehicles closer to the lead vehicle are likely to follow a path similar to the lead vehicle, while latter vehicles in the convoy are likely to be off the lead vehicle's path.

The present disclosure describes techniques that improve autonomous, multi-vehicle convoy movement, by treating the convoy as a linked system. The techniques allow position updates or sensor updates from multiple convoy vehicles to be used to generate more accurate position estimates than can be achieved from a single convoy vehicle.

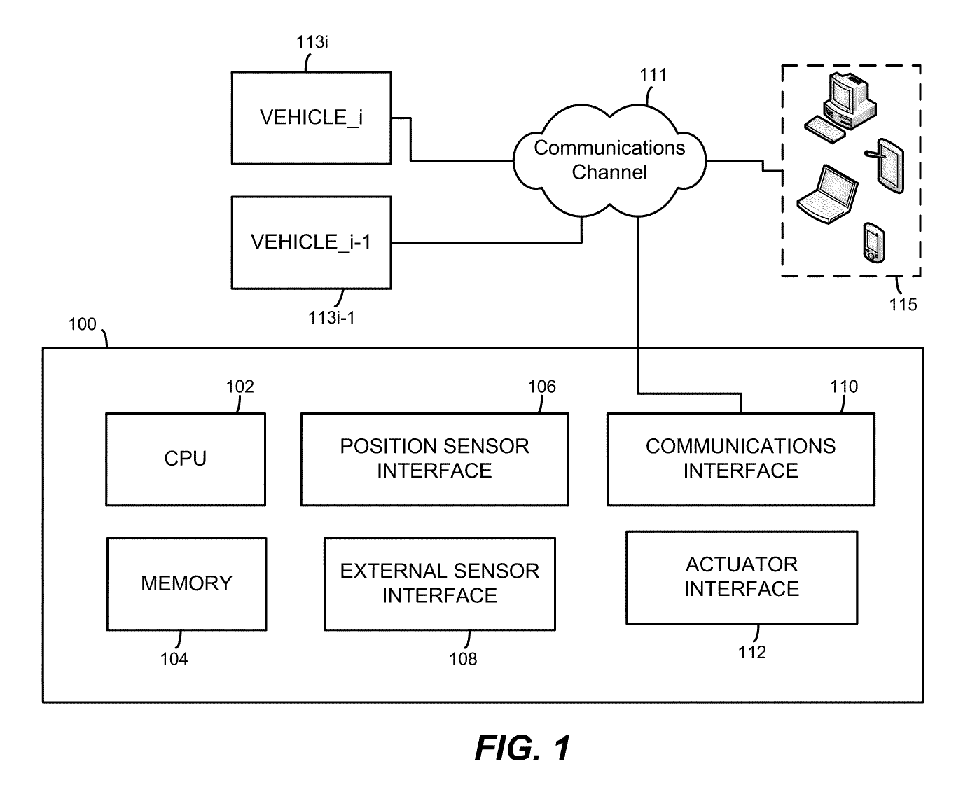

With reference to FIG. 1, a convoy vehicle may have a convoy vehicle control system 100. The control system 100 may include one or more of a CPU 102, a computer-readable memory 104, a position sensor interface 106, an external sensor interface 108, a communications interface 110, and an actuator interface 112 to execute the methods of the present disclosure. The features and alternative embodiments of the computing system 100 are described later in this disclosure. The convoy control system 100 may be implemented on one or more or all vehicles in a multi-vehicle convoy. In other examples, the control system 100 may be implemented in a centralized control system external to the multi-vehicle convoy. Within the multi-vehicle convoy, the control system 100 may be implemented in a centralized manner or in a distributed manner, where the latter includes point-to-point control or a mesh network distributed control.

### Improved Position Estimation

The present disclosure provides techniques for improving position estimates in multi-vehicle convoys. In some examples, the relative and global position estimation of vehicles in an n-vehicle convoy may be improved by treating the entire convoy as a linked system. By treating the entire convoy as a linked system, e.g., with a convoy state, a convoy vehicle's individual pose estimates will improve with each GPS and sensor observation from any other convoy vehicle. This approach can be applied to any vehicle convoy in which vehicles are equipped with a GPS sensor, or an equivalent position-measurement sensor, or with external sensors (measuring range, bearing, or both between adjacent vehicles), or with any combination of such sensors. Examples of external sensors include electrooptic (EO) or infrared (IR) cameras, radar, and lidar, as well as instrumented physical vehicle connections, such as a tether system connecting the vehicles and providing relative range and/or bearing data.

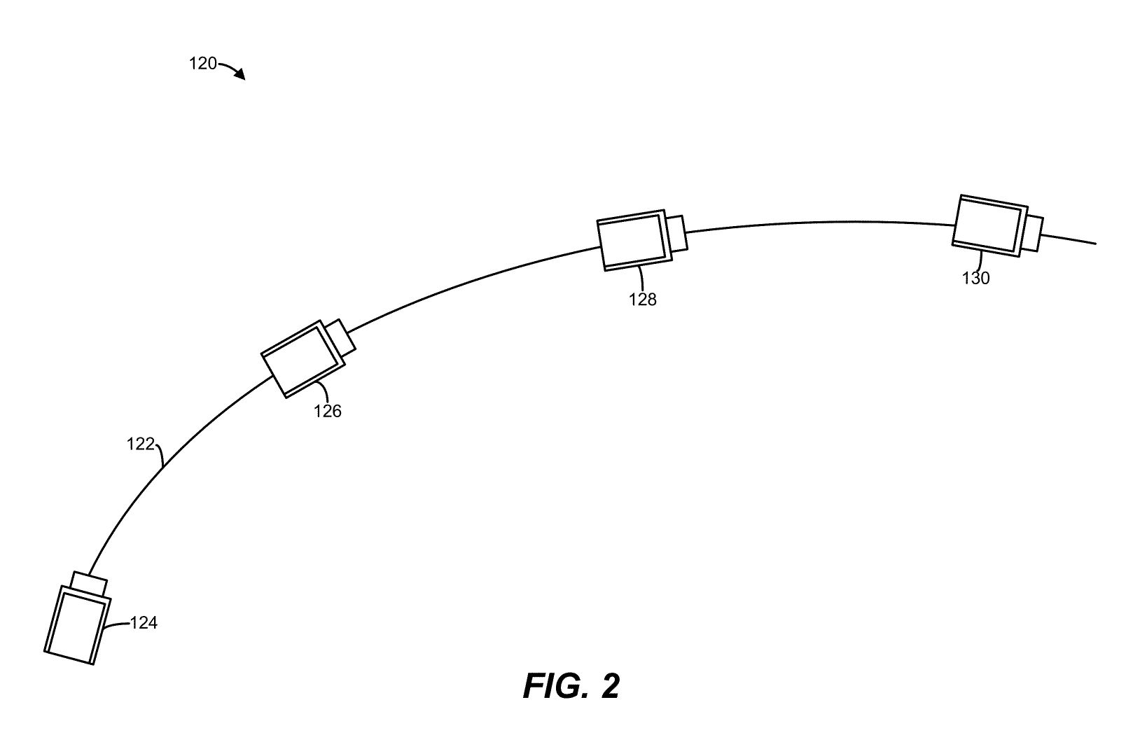

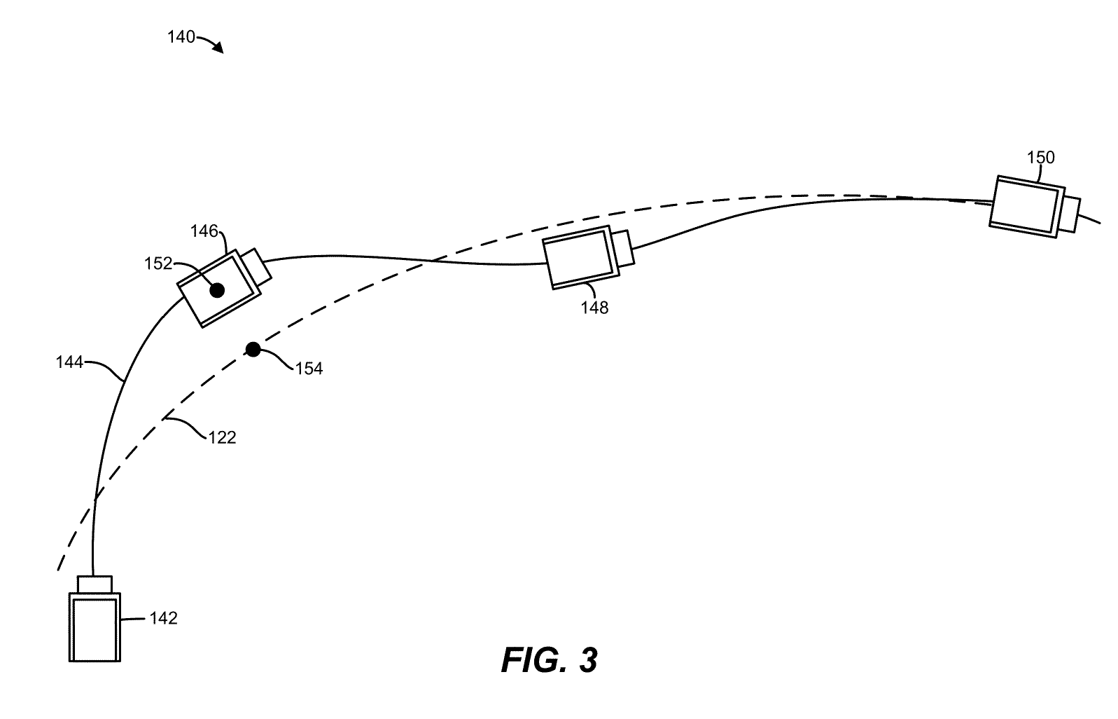

Consider FIG. 2, for example, which illustrates a convoy system 120 in which a lead vehicle 130 is part of a multi-vehicle convoy with follower vehicles 124, 126, 128. In a typical convoy operation, it is often desirable for the follower vehicles 124, 126, and 128 to follow the lead vehicle path 122 as closely as possible. While it might be possible to transmit the coordinates of the lead vehicle path 122 to the follower vehicles 124, 126, 128, many factors, including position system errors, may cause the follower vehicles 124, 126, 128 to deviate from the lead vehicle's path 122. FIG. 3 illustrates an example of such deviation, where the convoy vehicles at positions 142, 146, and 148 are off the lead vehicle path 122. The present disclosure provides techniques to allow the follower vehicles 142, 146, and 148 to return to the correct path when the follower vehicles 142, 146, 148 reach the position of the lead vehicle 150.

The control system 100 determines pose estimations for the vehicles in the convoy. As used herein, pose refers to position (or location) and orientation (or bearing, heading, or direction), or in the alternative to either position or orientation. The system 100 may, in some examples, employ an extended Kalman filter (EKF) to improve position estimations in the multi-vehicle convoy. An EKF is a two-step non-linear state estimation technique that uses a series of measurements over time to produce estimates of variables associated with those measurements that may include significant errors. In an embodiment, the system 100 uses an EKF to estimate the combined state of the entire convoy in order to estimate the location 152 of vehicle 146. To estimate location 154, a fixed-lag Kalman smoother may be used, for example. The locations 152 and 154 may be represented in any coordinate frame that is global to the convoy. In an embodiment, the coordinate system may be based on the global positioning system (GPS). In other embodiments, the coordinate system may be a global system established at a fixed or mobile location in proximity to the multi-vehicle convoy. When the coordinate system is based on GPS, observation errors for the estimated locations 152 and 154 (e.g., error due to atmospheric effects, multipath errors, etc.) will be highly correlated, since the GPS measurements are performed at closely related times and positions. The resulting estimate of the path deviation between the locations 152 and 154 will be more accurate than the underlying covariance matrix of the estimated locations 152 and 154 would suggest, since these correlated errors cancel in the deviation calculation.

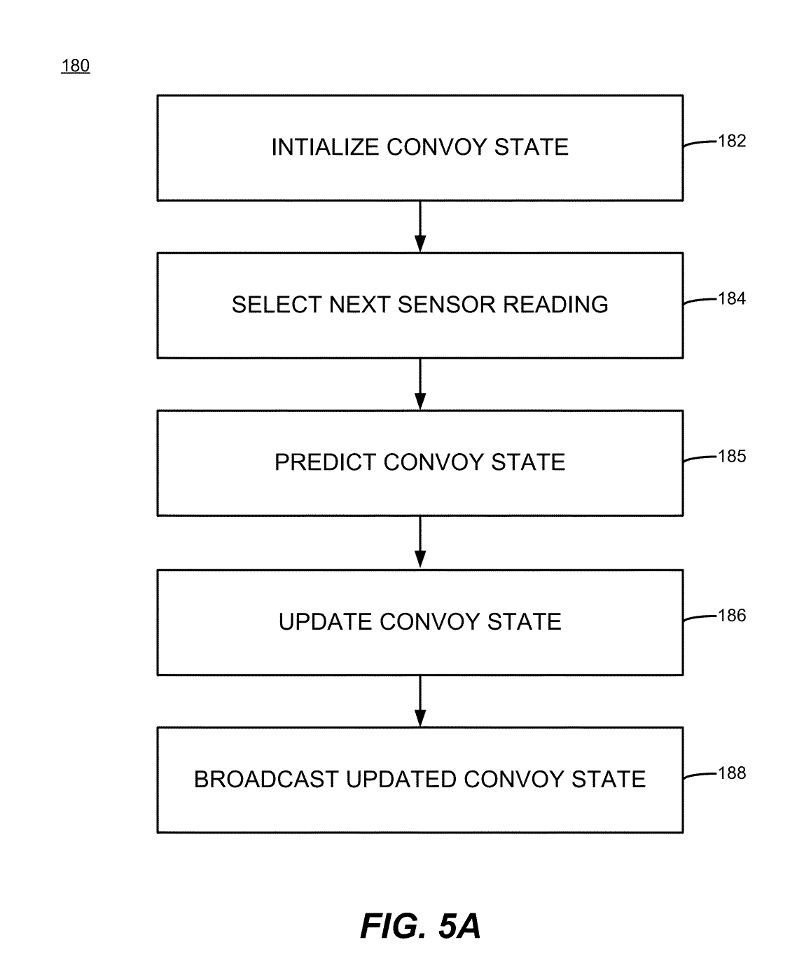

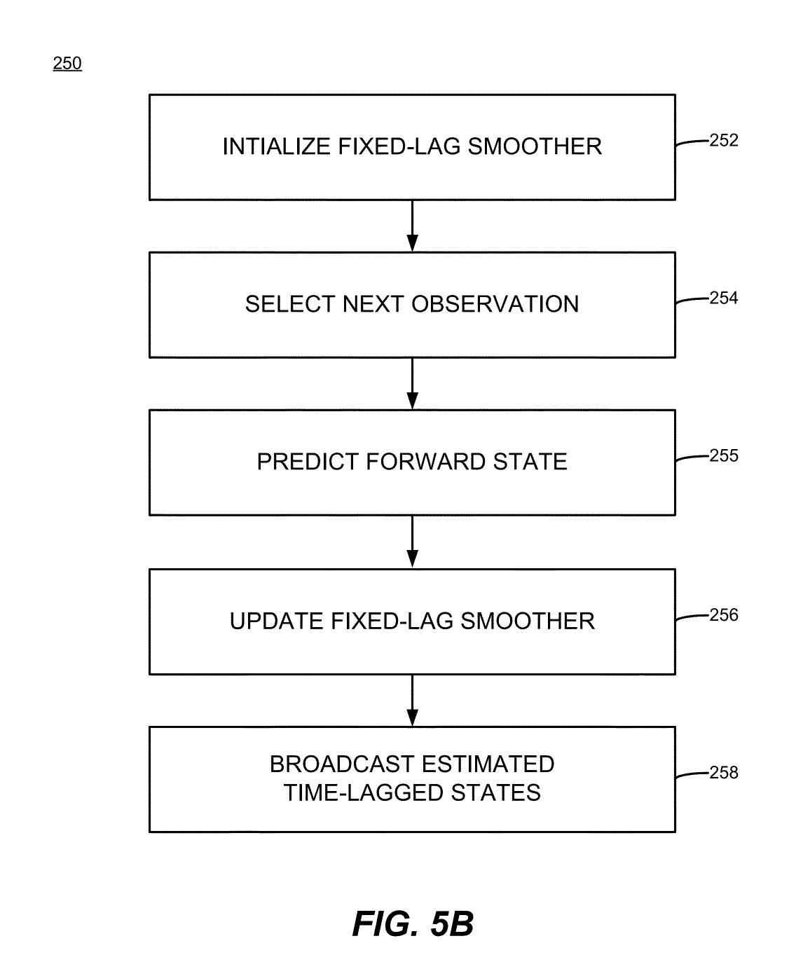

FIG. 5A illustrates a process flow diagram or flow chart of a method, routine, or process 180 that may be used in a computer-implemented method for improving pose estimations such multi-vehicle convoys. The process 180 may be implemented in the system 100, for example, either in a centralized manner or distributed manner.

A block 182 may initialize the convoy vehicle state. In an embodiment, the convoy vehicles (and vehicle ordering) may be defined by the operator. In another embodiment, the order of the convoy vehicles may be determined automatically, for example, by projecting each vehicle location onto a line and ordering the vehicles according to that projection. In an embodiment, the convoy vehicle state may represent the position, orientation, velocity, and steering wheel position of each of the vehicles in the multi-vehicle convoy. In an embodiment, the variables of the convoy state for each vehicle may be initialized from the GPS and sensors on-board the vehicle. In some embodiments, the variables may be received from a prior estimate of each vehicle's position or an external positioning system via the communication interface 110, for example. At the block 182, the process 180 may initialize vehicle states for each of the vehicles in the convoy. While illustrated as occurring for each vehicle together, in some examples, vehicle state initialization may occur as vehicles are added to an existing convoy of vehicles, for example, where the convoy state is updated to reflect vehicles being added or removed from the convoy. This may be useful, for example, in initializing vehicles as each vehicle in a long convoy leaves a forward operating base (FOB), check point, etc.

At a block 184, the process 180 selects a next sensor reading, for example, from a position sensor coupled to interface 106 or an external sensor coupled to interface 108. The block 184 may selected one or more sensor readings from one or more vehicles. One of the advantages of the present techniques is that as few as one sensor reading on one vehicle in a convoy may be used to affect change to the convoy state and determine control commands to correcting the pose of any other vehicle in the convoy. This few-to-many relationship is facilitated in part by defining an overall convoy state, instead of performing vehicle measure, adjustment, and control on a per vehicle basis only. Moreover, in some implementations, any sensor, whether internal GPS, external observation, or otherwise, from any vehicle can be used to update the convoy state and correct for deviation in any and all vehicles in the convoy. Considering the convoy as an entire state, the present techniques are able to achieve more accurate, faster control of convoy pose and movement. Changes to a lead vehicle, for example, can be used to correct for pose of any one or more follower vehicles, and vice versa.

Any of a number of sensor types may be used; and generally the sensors are continuously or nearly continuously collecting reading data. While, in some examples, sensors may be polled to collect readings. In any event, the external sensors may include electrooptic (EO) or infrared (IR) cameras, radar, and lidar, as well as instrumented physical vehicle connections, such as a tether system connecting the vehicles and providing relative range and/or bearing data.

The block 184 may select the next sensor reading in a decisional manner. For example, in an embodiment, the order in which position and external sensor readings are prioritized may be temporal, starting with the earliest reading. In another embodiment, they may be selected by a prioritized scheme. The next sensor reading may be determined based on historical data, identifying historical sensor reading data. The block 184 may apply thresholding, gating, or banding analyses to the sensor readings to identifying erroneous sensor readings, such as spikes in readings, that should not be used for updating a convoy state. For example, the block 184 may determine if a particular sensor reading has not sufficiently changed enough to justify using it for convoy correction or has changed by too great an extent. In some examples, the block 184 may have compare sensor readings across different sensor types and/or different vehicle sensors, to determine a preferred sensor reading from among the sensor readings. In some examples, sensor readings may be gated against sensor-specific conditions and discarded in order to filter out spurious readings.

At a block 185, the process 180 may predict the convoy state forward in time by a discrete time increment at a point in time. The block 185 may predict position, orientation, velocity, steering wheel position, etc. for each vehicle in the convoy at the future point in time. The block 185 for example may use an EKF engine for predicting vehicle position estimations for future time periods.

At a block 186, the process 180 may update the convoy state with the sensor reading obtained from block 184 using the EKF engine.

Via block 188, the process 180 then broadcasts the updated convoy state of the vehicle to other vehicles in the convoy, for example through the communications interface 110. In some examples, the updated convoy state may be communicated to all vehicles in the convoy or only to those vehicles determined (not shown) to be affected by the updated convoy state, e.g., those vehicles like vehicle 146 having a pose that deviates from the desired pose. The control system 100 may transmit its updated convoy state to each of the vehicles in the convoy, either in a multicast broadcast manner, point-to-point manner, or otherwise. In some examples, the estimations for all vehicles may be communicated to a centralized control station for convoy monitoring and movement control.

To implement convoy state predictions and updates, the control system 100, in particular the processes 180, 250, 230, 260, and 270, may employ an EKF engine using a state transition model, or state vector, xₖ=f(xₖ₋₁,uₖ₋₁)+wₖ₋₁ and an observation model zₖ=h(xₖ)+vₖ. In an embodiment, the state vector for the EKF engine may include the position and orientation of each vehicle in the convoy. In other embodiments, the EKF may include other vehicle state features such as the vehicle's velocity and estimated inertial measurement unit (IMU) biases.

In an embodiment of the present disclosure, the EKF engine's prediction step is accomplished by propagating each vehicle's position forward in time using a kinematic model of the vehicle. An update to the EKF may be initiated with every inter-vehicle range and angle observation. In addition, the EKF may be updated with each update of a vehicle's navigation solution. Since, in this formulation, the vehicle positions are linked, each update step can modify the position of every vehicle in the convoy. The process can apply equally to loosely-coupled and tightly-coupled EKFs.

In an example, the state vector xₖ at time k would include the state Sₖⁱ of each vehicle in the N-vehicle convoy. Therefore,

$${x}_{k} = [ \begin{matrix}{S}_{k}^{o} \\ {S}_{k}^{1} \\ ⋮ \\ {S}_{k}^{N - 1}\end{matrix} ] .$$

In an example, a vehicle state may be represented by a northing, easting, and theta orientation angle,

$${S}_{k}^{i} = [ \begin{matrix}{X}_{k}^{i} \\ {Y}_{k}^{i} \\ {θ}_{k}^{i}\end{matrix} ] .$$

However, in other examples, the vehicle state may also include or be represented by one or more of steering wheel angle, latitude, longitude, elevation, roll, pitch, yaw, velocity, acceleration, jerk, etc.

The control vector u is the aggregate of the controls for each individual vehicle,

$${u}_{k} = [ \begin{matrix}{U}_{k}^{o} \\ {U}_{k}^{1} \\ ⋮ \\ {U}_{k}^{N - 1}\end{matrix} ] .$$

The controls may include commanded throttle, brake, steering, linear velocity, angular velocity, and the like. In an embodiment, the control vector may include only commanded linear velocity and angular velocity.

$${U}_{k}^{i} = [ \begin{matrix}{V}_{k}^{i} \\ {\dot{θ}}_{k}^{i}\end{matrix} ]$$

In an embodiment of the present disclosure, the EKF update equation updates each vehicle

$$f ( {x}_{k - 1} , {u}_{k - 1} ) = [ \begin{matrix}F ( {S}_{k - 1}^{o} , {U}_{k - 1}^{0} ) \\ F ( {S}_{k - 1}^{1} , {U}_{k - 1}^{1} ) \\ ⋮ \\ F ( {S}_{k - 1}^{N - 1} , {U}_{k - 1}^{N - 1} )\end{matrix} ]$$

In this embodiment,

$$F ( {S}_{k - 1}^{i} , {U}_{k - 1}^{i} ) = F ( [ \begin{matrix}{X}_{k}^{i} \\ {Y}_{k}^{i} \\ {θ}_{k}^{i}\end{matrix} ] , [ \begin{matrix}{V}_{k}^{i} \\ {\dot{θ}}_{k}^{i}\end{matrix} ] ) = [ \begin{matrix}{X}_{k - 1}^{i} + {V}_{k - 1}^{i} Δ t cos θ \\ {Y}_{k - 1}^{i} + {V}_{k - 1}^{i} Δ t sin θ \\ {θ}_{k - 1}^{i} + {\dot{θ}}_{k}^{i} Δ t\end{matrix} ]$$

Assuming that the ith vehicle is equipped with lidar, vision, or radar sensors that allow the ith vehicle to observe the state of the (i−1)th vehicle (i.e., vehicle 1 can observe vehicle 0, vehicle 2 can observe vehicle 1, etc.), then the model for an observation h(xₖ) of a sensor reading of the ith vehicle from the i−1th vehicle will have the form h_{intervehicle-sensor-y}(xₖ)=(Sₖⁱ⁻¹,Sₖⁱ), whereas the navigation sensors (GPS, IMU, etc.) will be a function of just a single vehicle hₙₐᵥ₋ₛₑₙₛₒᵣ(xₖ)=h(Sₖⁱ).

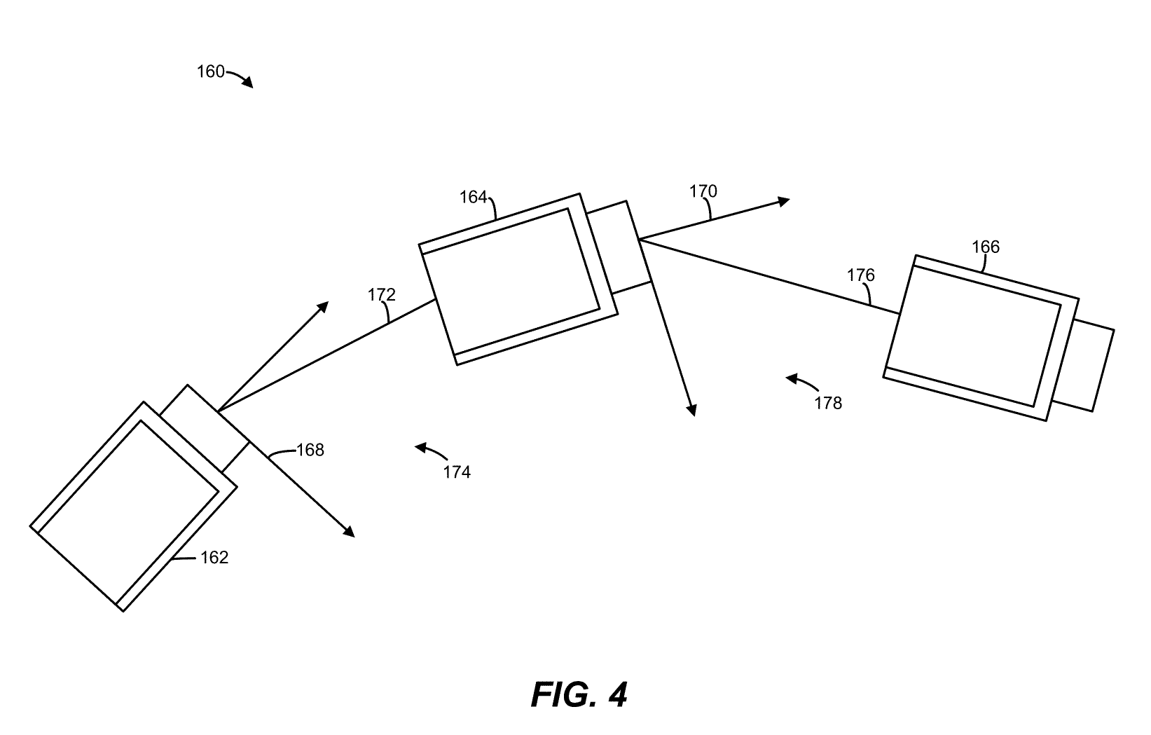

As shown in FIG. 4, vehicle 162 may measure the location of vehicle 164 within vehicle 162's coordinate system 168. For example, the position of vehicle 164 may be represented in polar coordinates of the coordinate system 168, represented by the distance 172 and angle 174. Similarly, vehicle 164 may measure the location of vehicle 166 within vehicle 164's coordinate system 170. The position of vehicle 166 may be represented in polar coordinates represented by the distance 176 and angle 178. In other embodiments, the position of vehicle 164 with respect to vehicle 162 may be represented in Cartesian coordinates. Similarly, the position of vehicle 166 with respect to vehicle 164 may be represented in Cartesian coordinates.

Given only navigation sensor readings, the covariance matrix Pₖ will be block diagonal, indicating coupling only of different aspects of the vehicle state within the same vehicle. For example, the covariance matrix may have the form

$${P}_{k} = [ \begin{matrix}{P}_{k}^{0} & & & \\ & {P}_{k}^{1} & & \\ & & ⋱ & \\ & & & {P}_{k}^{N - 1}\end{matrix} ] .$$

However, coupling of vehicle states (e.g., updating one state given navigation or inter-vehicle sensor data) will occur automatically, using the standard EKF update equations, once one or more inter-vehicle sensor readings occur. Mathematically, the coupling is introduced as a result of the Jacobian from the h_{intervehicle-sensor} (xₖ) readings. During the EKF update step, this will introduce non-zero covariance elements into the state update equations, representing the coupling of different vehicle states. After a single inter-vehicle observation of v₀ from v₁, for example, the covariance may take the form of

$${P}_{k} = [ \begin{matrix}{P}_{k}^{0} & {P}_{k}^{01} & & \\ {P}_{k}^{10} & {P}_{k}^{1} & & \\ & & ⋱ & \\ & & & {P}_{k}^{N - 1}\end{matrix} ] ,$$

with Pₖ¹⁰ and Pₖ⁰¹ having non-zero elements.

The fixed-lag Kalman smoother computes a state vector estimate over a time series from t−t_{maxlag} to t. In an embodiment, the Kalman smoother employs the Rauch-Tung-Striebel algorithm, which propagates estimated states backward in time. A fixed lag Kalman smoother will compute a state vector estimate (of the lead vehicle only) over a time series from t−t_{maxlag} to t. The sensor and vehicle models used in the Kalman smoother are the same as those described previously. The fixed-lag smoother allows the state vector at times between t−t_{maxlag} to t to be improved by both preceding and subsequent observations. In an embodiment, t_{maxlag} need go back a few seconds, being greater than the time difference between the first and last convoy vehicle's passing any particular fixed point. Observations for this estimator will be extracted from the lead vehicle state portion of the convoy state estimated via the EKF above.

A variety of fixed-lag algorithms have been developed. In an embodiment, the Rauch-Tung-Striebel (RTS) smoother may be used. RTS uses a two-pass approach, using a standard EKF for the forward pass followed by a smoothing backwards pass that updates past estimates within a short time window.

In an embodiment, the state vector estimate is of the lead vehicle only. In another embodiment, the state vector applies to the entire convoy. The sensor and vehicle models used are the same as the ones described above; the standard fixed-lag equations allow the state vector at times between t and t−t_{maxlag} to be informed by both preceding and subsequent observations. In some embodiments, t_{maxlag} need only go back a few seconds, and need only be greater than the time difference between the first and last convoy vehicles passing any particular fixed point. In some embodiments, observations for this estimator will be extracted from the lead vehicle state portion of the convoy state estimated via the EKF above. In other embodiments, observations for this estimator may include individual sensor readings from each vehicle.

FIG. 5B illustrates a process flow diagram or flow chart of a method, routine, or process 250 that may be used in a computer-implemented method for estimating the lead vehicle state between time t and t−t_{maxlag}

In an embodiment, a block 252 may initialize the fixed-lag Kalman state of all convoy vehicles. In another embodiment, block 252 may initialize the fixed-lag Kalman state of the lead vehicle only. In an embodiment, the variables of the convoy state that correspond to a particular vehicle may be initialized from a GPS receiver or other sensors on-board that vehicle.

At a block 254, the process 250 may select a position sensor observation or an external sensor observation (observation in this context is synonymous with sensor reading. In an embodiment, the order in which sensor readings are prioritized may be temporal, starting with the earliest reading. In another embodiment, they may be selected by a prioritized scheme. In an embodiment, sensor readings may be gated against sensor-specific conditions and discarded, to filter out spurious readings. In another embodiment, the observations for this estimator may be extracted from the lead vehicle state portion of the convoy state estimated via the EKF above.

In an embodiment, at a block 255, the process 250 may predict the state of the lead vehicle at a forward point in time, for example, using known estimation techniques. In another embodiment, the process 250 may predict the state of the entire convoy at a forward point in time, using known estimation techniques.

At a block 256, the process 250 may update a fixed-lag smoother state using the observation from block 254 or the state from block 255. In an embodiment, the fixed-lag state may be updated using the Rauch-Tung-Striebel algorithm. In an embodiment, the fixed-lag state may be updated using methods known in the art.

At a block 258, the process 250 may broadcast the estimated lead vehicle state from time t to t_{maxlag}. This estimated convoy state may be transmitted to some vehicles in the convoy, such as those vehicles determined to be affected by the estimated convoy state. For example, the system 100 may determine that only a subset of vehicles is affected by the determination of an updated convoy state.

The above-described technique is framed using a description of an EKF (extended Kalman filter). However, for some vehicle/sensor systems, better results may be achieved using an unscented Kalman filter instead. During the prediction step, the unscented Kalman filter estimates the new covariance by sampling a number of points around the current state and propagating them through the process model to obtain a new distribution from which the new covariance is calculated. This is contrasted with the EKF, which uses the Jacobian to estimate the new covariance. Similarly, during the sensor update step, the new covariance is computed by sampling a number of points surrounding the sensor measurement and propagating those points through the sensor model, again in contrast to the EKF which uses the Jacobian. In an embodiment of the present disclosure, the unscented prediction step may be used rather than the EKF update. Alternatively or additionally, the unscented update step may be used rather than the EKF update step.

In yet another embodiment of the present disclosure, a particle filter may be used to estimate the mean and distribution of the vehicle's positions. Particle filters explicitly track a multitude of simultaneous system state estimates, instead of a single state; each state estimate is updated from both the prediction model and the sensor process model.

### Improved Vehicle Control

The present disclosure also improves path-following control for convoy vehicles following a lead vehicle. This is accomplished using a control sequence planner that exploits both the lead vehicle's path and the control history (e.g., time series of steering and throttle commands) that generated that path. This technique requires only that the following vehicles have a method for receiving estimates of the lead vehicle's path and past control history. These estimates may be transmitted or received via the communications interface 110 illustrated in FIG. 1.

Traditional vehicle control methods have relied purely on estimates of the positions of one or more of the vehicles in front of a follower vehicle, along with the path of those vehicles. The pure-pursuit algorithm has been applied for this purpose, for example. However, a known problem with these traditional approaches is that even given perfect knowledge of the positions of all vehicles, the resulting control will not perfectly follow the path. These algorithms tend to cause vehicles to cut corners or become unstable depending on how algorithm gains are tuned.

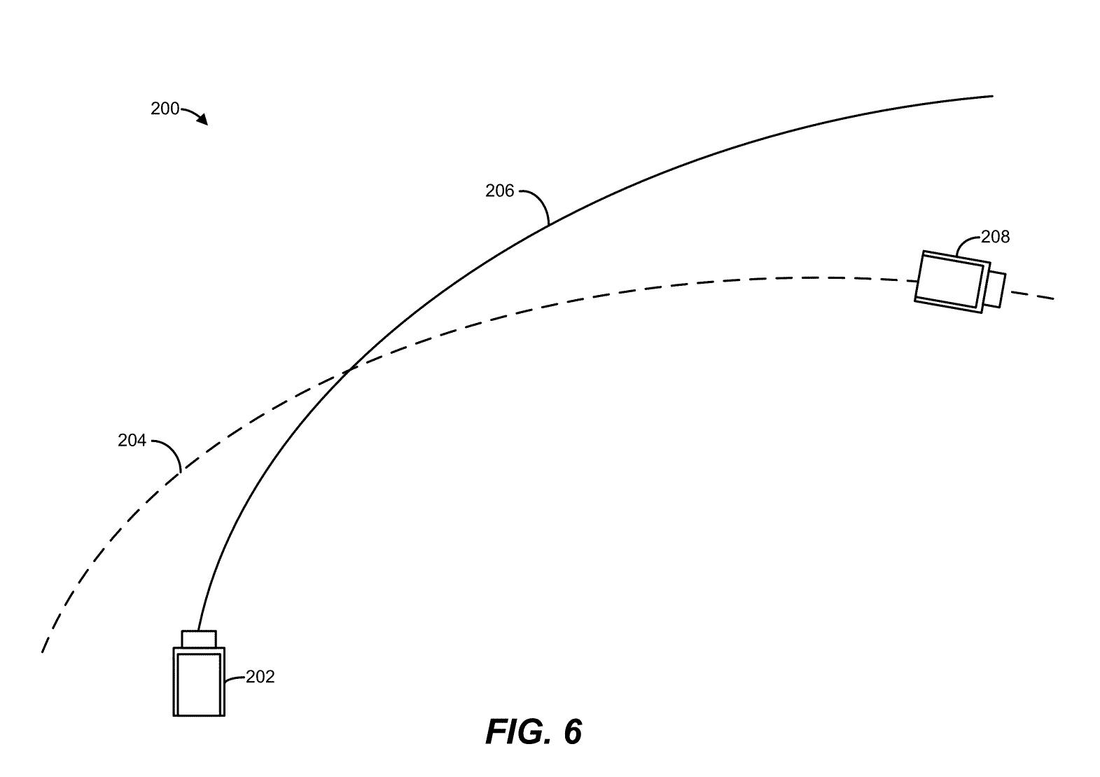

In the example of FIG. 6, the errors with traditional vehicle control methods can be reduced by passing to a vehicle 202 an additional data stream that represents a control sequence, C₀, that includes the time series of control commands or signals that caused vehicle 208 to execute the path 204. The control commands or signals may include steering, throttle, and brake commands, but may include any command that caused vehicle 208 to execute the path 204. Therefore, the data stream representing the control sequence C₀ has the known property that, for a vehicle that is on the path 204, the control sequence C₀ resulted in exactly the path that needs to be followed. If the vehicles in the convoy (e.g., vehicle 202) are all of similar type and exhibit similar control responses (e.g., control lag, actuator power limits, and the like) as the vehicle 208, C₀ serves as an ideal starting point for estimating the control inputs required for causing vehicle 202 to emulate and follow vehicle 208's path.

The control sequence data C₀ of vehicle 208 may be used in numerous ways. Generally speaking, the present techniques need not duplicate the control sequence C₀ of vehicle 208 when issuing controls for vehicle 202. One reason for this is that vehicle 202's position will likely be at least slightly different from vehicle 208's position at the same point along the path. As such, the present techniques may use an iterative, gradient-descent, non-linear optimization routine to compute Cᵢ^{optimal} given C₀ as the input seed. This approach improves upon known techniques, because, unlike known techniques that use as an input seed a result of a forward vehicle dynamic simulation, the present techniques may use a time-history of controls from a lead vehicle. Furthermore, many of the known methods (e.g., the receding horizon control methods) were developed for single vehicles and are not extendible to multi-vehicle convoys.

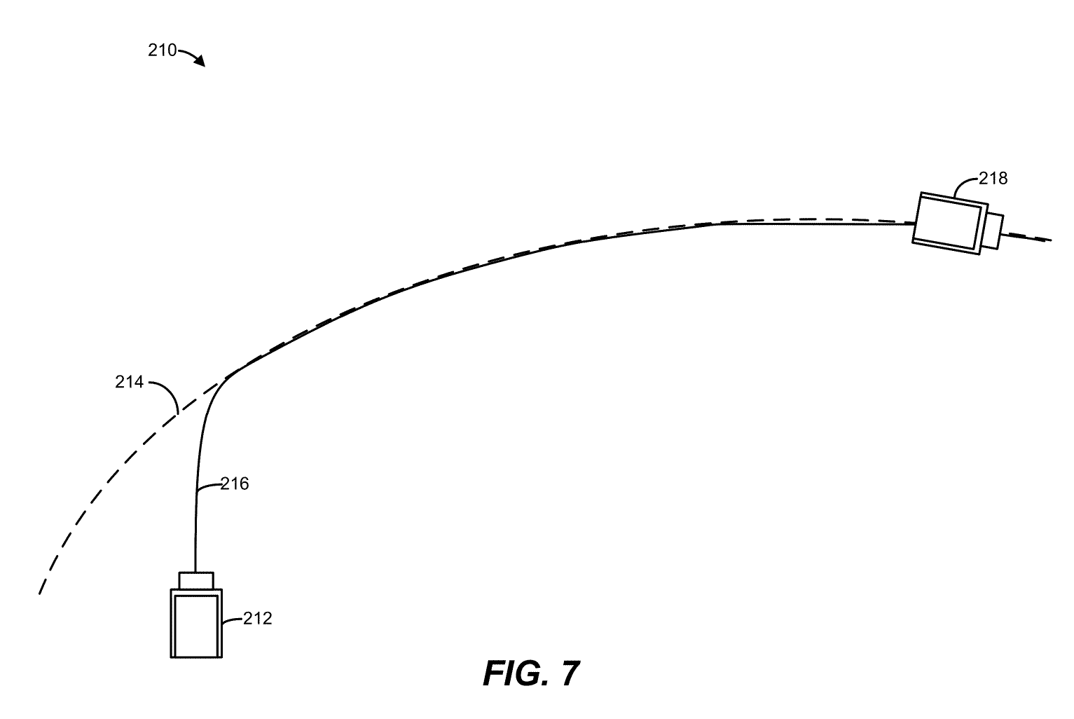

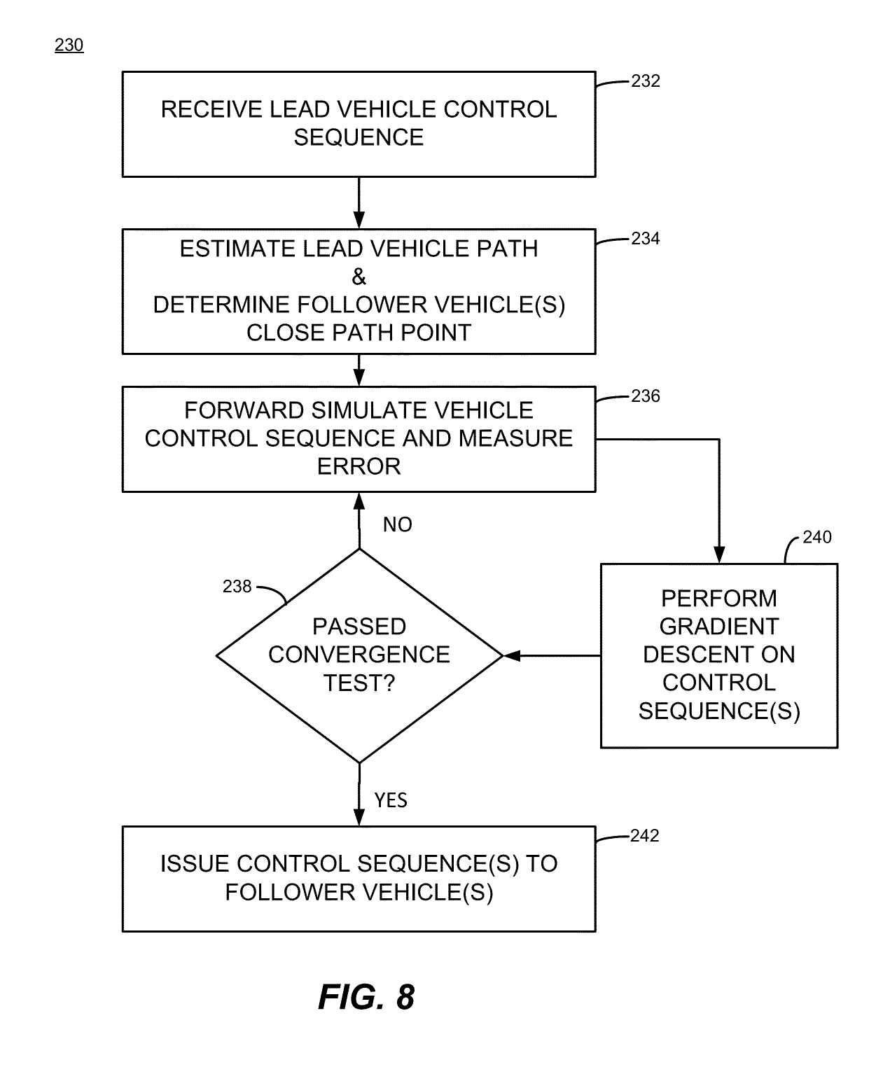

FIGS. 6 and 7 illustrate parts of the path optimization process in accord with an example. Recall that path 204 is the original path followed by vehicle 208. This path 204 resulted from the control sequence C₀ being applied to vehicle 208. If the vehicle 202 were to execute the control sequence C₀, it would likely traverse path 206, rather than the desired path 204, for example, due to differences between the vehicles in position, vehicle type, payload, measured responsiveness to control signals, etc. By implementing the method illustrated in FIG. 8, vehicle 212 of FIG. 7 can be made to follow the path 216, which substantially overlaps the path 214 followed by vehicle 218. That is the path deviation that would result from merely applying the control sequence C₀ to vehicle 202, as shown in FIG. 6 is corrected for in the example of FIG. 7, between paths 216 and 214.

Preliminary results of implementations show that trailing vehicles (such as vehicle 212 of FIG. 7) follow the lead vehicle path much more closely compared to conventional techniques. In example implementations, the present techniques have improved path accuracy for trailing vehicles between 25% and 90% over conventional techniques, such as pure-pursuit control.

FIG. 8 illustrates a process flow diagram or flow chart of a method, routine, or process 230 that may be used in a computer-implemented method for improving path following control for convoy vehicles following a lead vehicle.

A block 232 may receive, at a follower vehicle, a lead vehicle's path and controls history, collectively forming a control sequence. The path of the lead vehicle may be transmitted either from the lead vehicle itself or from a centralized convoy state estimation system, for example the improved position estimation system described above. This transmission can occur as a single data transfer or as a number of incremental data transfers over time. The current estimated distance between vehicle 202 and the lead vehicle 208, padded with a safety margin, can be used to determine how much of the lead vehicle's path 204 and history is to be made available to vehicle 202. If, for example, vehicle 202 trails the lead vehicle 208 by 50 meters, the path and control history of the lead vehicle 208 for the past 60 m (50.0 m*120%=60 m) can be transmitted to vehicle 202, reflecting a 20% safety margin. The amount of the safety margin may be fixed or determined on-the-fly during convoy movement. The safety margin may be based on historical deviation data, data about the position and/or speed of the vehicles in the convoy, and other factors.

At a block 234, the process 230 may estimate the past path of the lead vehicle 208, i.e., path 204, and then determine for the vehicle 202 the closest point on that estimated path. The calculated control sequence for vehicle 202 is initialized to the control sequence of lead vehicle 208 starting from this closest point. Thus, in the example of FIG. 6, the path 206 would result from merely applying the control sequences for vehicle 208 that resulted in path 204, that is, for the initial iterative state of the process 230, before correction.

A block 236 may forward simulate, starting from the current pose for vehicle 202, the current calculated control sequence. Unlike known methods, the present techniques can forward simulate using the control sequence and a known vehicle path. Thus, the simulation of the present disclosure may use a vehicle dynamics model to take the current calculated control sequence and generate a set of control sequences for the trailing vehicle using the path estimated via the block 234 and the closest point on that estimated path determined via block 234. The vehicle dynamics model varies with the vehicle type and can be as basic as a bicycle model, or may be a more complex, including models of vehicle suspensions and other more complex vehicle dynamics, for example. For an autonomous vehicle system, the model may include parameters estimating the control delay, which models the time lag between when control computation begins to the time it affects the vehicle. The vehicle dynamics model applied via the block 236 may include vehicle dynamics data for the trailing vehicle or, in some examples, for both the trailing vehicle and the lead vehicle.

A block 240 may perform gradient descent on the above-described control sequence that caused the lead vehicle 208, 218 to execute the path 204, 214. Here, the vehicle controls (e.g., throttle, brake, steering, other mobility commands) are parameterized and numerical optimization is performed on the control sequence values. Thereafter, the calculated trajectory 206, 216 of the follower vehicle 202, 212 is scored based on its difference from the lead vehicle path 204, 214. Thus, FIG. 6 may be viewed as illustrating an initial iteration of the process 230, whereas FIG. 7 illustrates applying vehicle-specific control sequences, optimized from those of the lead vehicle, to result in the improved path 216, which essentially coincides with the lead vehicle path 214, albeit is achieved with block 240 optimizing the control sequences from the lead vehicle into appropriate control sequences for follower vehicles. While the example is described based on control sequences from the lead vehicle, the control sequences may be from any vehicle in the convoy, albeit generally speaking the control sequences should be from vehicles in a frontward order compared to the other vehicles. The block 240 may perform the gradient descent on a control sequence for one or more of the vehicles in the convoy, for example.

A broad choice of parameterizations may be used for the control sequence. For example, a polynomial spline may be fit separately to each dimension of the control vector, with the coefficients of the polynomial serving as the variables for the gradient descent.

In addition, a broad choice of numerical minimization techniques may be used. For example, Newton or quasi-Newton methods (such as Powell's method or other conjugate gradient methods) may be used. Derivatives of the dynamics model may or may not be required for minimization, depending on the method employed.

A block 238 may determine if the numerical optimization and gradient descent operations have cause the calculated trajectory 206, 216 (or trajectories when dealing with multiple vehicles simultaneously) to substantially converge to the lead vehicle path 204, 214. For example, the block 238 may determine if a convergence test has been passed. If the calculated trajectory 206, 216 does not pass the convergence test, the current calculated control sequence is updated to the result of the operations of the gradient descent block 240 and the forward simulation block 236 are repeated until the convergence tests of block 238 are successful.

If the convergence test is passed control is sent to a block 242, which may issue the forward simulated control sequence to the follower vehicle 202, 212. Because of the forward simulation and gradient descent operations of blocks 236 and 240, the vehicle 212 should execute the path 216, absent any external disturbances.

In an embodiment, the previously discussed parameters of the vehicle dynamics model may be known a priori based on manufacturing specifications of the convoy vehicles. In an embodiment, the parameters of the vehicle dynamics model may be individually measured from the vehicles in question. In an embodiment, the entire set of model parameters may be learned using statistical machine learning techniques. For example, given a time-sequence log of vehicle controls and vehicle position and given predicted vehicle positions generated by the model based on logged vehicle controls, model parameters that minimize the error between the logged and predicted vehicle position can be calculated.

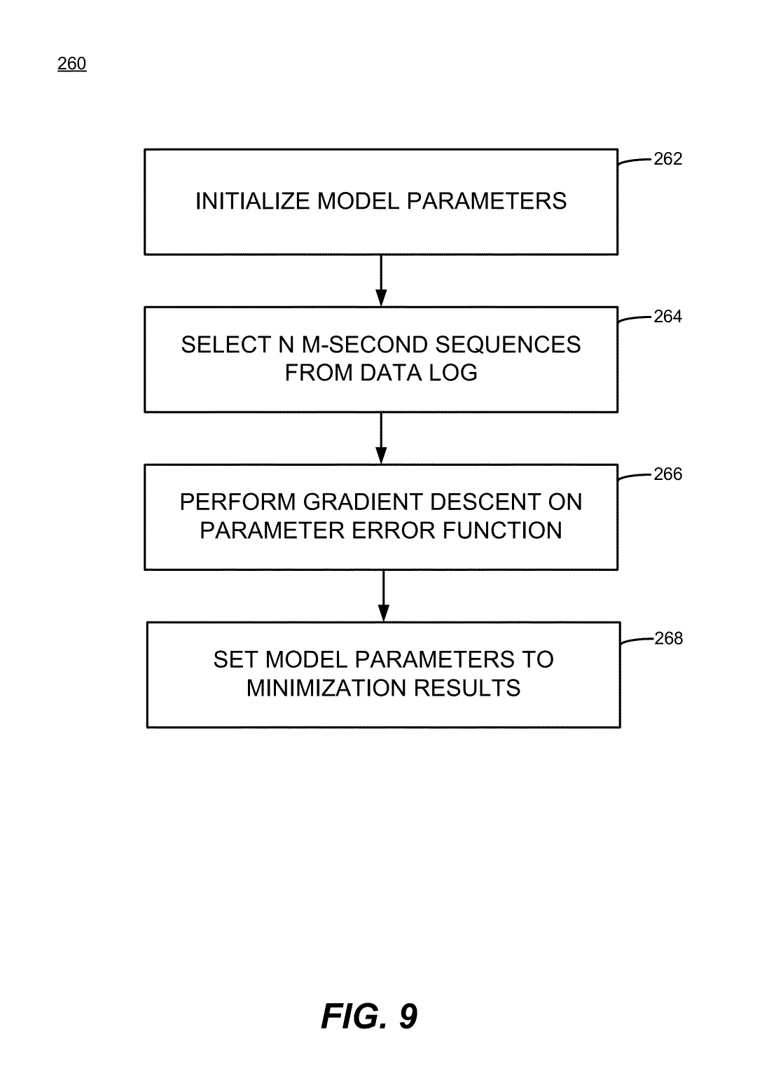

In an embodiment, a model parameters learning algorithm may be implemented using a process 260 shown in FIG. 9. In block 262, the model parameters may be initialized from convoy vehicle manufacturer specifications. In block 264, N M-second sequences S1 . . . SN of trajectory data may be selected from logged data. In block 266, gradient descent may be performed on the error function of E(CP, S1 . . . SN) with CP as free variables. In an embodiment, the free variables CP correspond to the control sequence parameters described hereinabove. In an embodiment, this gradient descent process may be implemented with Powell's method. In block 268, the optimal vehicle parameters are the result of CP after the nonlinear minimization in block 266.

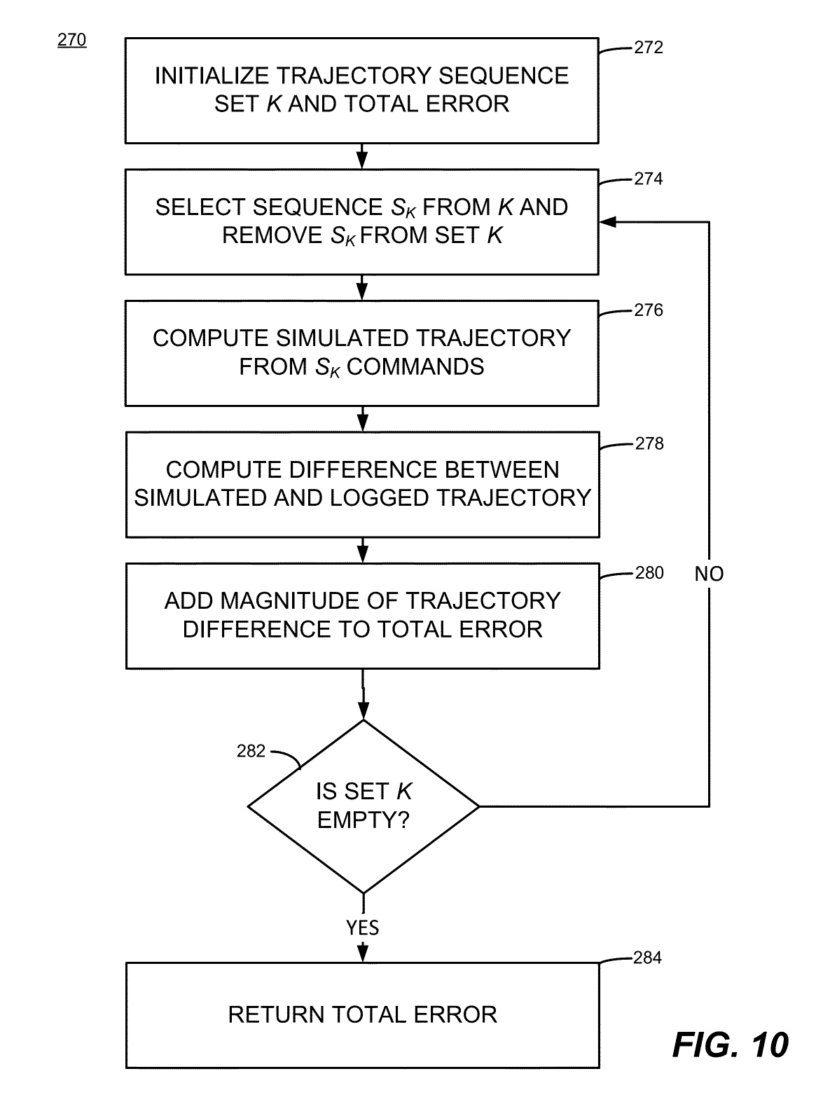

In an embodiment, the measured error function E(CP, S1 . . . SN) is implemented using the process 270 in FIG. 10. The process 270 may be executed by the block 266 of FIG. 9, for example. Generally speaking, FIGS. 9 and 10 establish vehicle model parameters that may be used to more accurately initialize and update convoy states in process 180, observe sensor readings in process 250, and forward simulate lead vehicle control sequences and determine follower vehicle control sequences in process 230.

In block 272, a variable ParamError is initialized to 0, and a set K is initialized to the set of all trajectories (S1 . . . SN), where N is the total number of trajectories used for the learning process. In block 274, a trajectory S_{K} (where 1<=K<=N) is selected from set K and removed from set K. In block 276, an M-second simulated trajectory TrajSim(S_{K}) is computed from the M-second command sequence contained in S_{K}, beginning from the vehicle position contained at the first logged position in Sn, and simulating forwards in time using vehicle model parameters Cp. In block 278, a value TrajError(S_{K}) is computed by calculating the difference between TrajSim(S_{K}) and the M-second trajectory of vehicle poses contained in S_{K}. In block 280, TrajError(S_{K}) is added to ParamError. Blocks 274 through 280 repeat until the exit criteria in block 282 is met. In block 284, the value of E(CP, S1 . . . SN) is the value of ParamError after the convergence criteria in block 282 is met.

In an embodiment, the entire set of model parameters may be learned during real-time operation, using an Extended Kalman filter, The innovation measurements (observations) for this filter are the errors between observed vehicle position at time Tb=PObserved(Tb) and predicted vehicle position at time Tb=PPredicted(Tb). PPredicted(TB) is computed from the model starting from the vehicle pose at Ta and applying vehicle controls from Ta to Tb in sequence.

In an embodiment, the same vehicle model may be used for all vehicles. In another embodiment, different models may be used by each vehicle, since one or more of the vehicles in the convoy may exhibit different control characteristics and/or vehicle dynamics than the other vehicles. Because the present disclosure uses a vehicle's dynamic model, the one or more different vehicles may also benefit from the present disclosure using a translator that converts from the control sequence of the first type of vehicle to the expected control sequence of the second type of vehicle.

In FIG. 1, the vehicle convoy control system 100 includes a central processing unit (CPU) 102. The CPU may be any computing device capable of receiving and executing instructions from a non-transitory computer-readable memory 104. For example, the CPU may be an x86 computer processor, a Power Architecture computer processor, a digital signal processor (DSP), a field-programmable gate array (FPGA), and application-specific integrated circuit (ASIC), a general purpose graphics processing unit (GPGPU), a microcontroller, or the like.

The non-transitory computer-readable memory 104 may be any device capable of temporarily or permanently storing, among other things, instructions executable by the CPU 102. The non-transitory computer-readable memory 104 may be random access memory (RAM), read-only memory (ROM), flash memory, a mechanical hard drive, a solid state hard drive, a CD-ROM, a DVD, or the like.

The CPU 102 may interface with a position sensor interface 106. The position sensor interface 106 receives data related to a vehicle's position. The position may be a global position or a local position. Position data may be received from a Global Positioning System (GPS) receiver, a site-specific positioning system, or any other positioning system able to provide discrete position information to a plurality of vehicles.

The CPU 102 also may have an external sensor interface 108. The external sensor interface 108 receives, among other things, data related to any vehicle sensors capable of receiving data regarding the locations of other vehicles in proximity to a vehicle with the computing system 100. The external sensor interface 108 may interface with both active and passive sensor systems. For example, the external sensor interface 108 may receive data from radar sensors, lidar sensor, camera sensors, or any other wireless sensor system. In addition, the external sensor interface 108 may receive data from sensor systems physically connected between a first vehicle and a second vehicle, for example a physical tethering system between the vehicles capable of providing relative position data. The external sensor interface 108 may provide the locations of other vehicles as global coordinate, local coordinates, or any other method capable of providing distinct and repeatable vehicle location data. Coordinates may be represented in Cartesian coordinates, polar coordinates, or in any other coordinate frame capable of representing distinct and repeatable vehicle locations.

The CPU 102 may interface with a communications interface 110 coupled to a communications channel 111. The communications interface 110 may establish communications between one or more of plurality of vehicles 113i and 113i−1 in a multi-vehicle convoy. The communications channel 111 may offer direct communications, indirect communications, a centralized network, a mesh network, or the like. For example, for direct communications, the communications interface 110 may establish a point-to-point connection with a vehicle 113i or 113i−1 as the channel 111. This may be accomplished, for example, via a tethered link between two or more vehicles. In another embodiment, the direct communications link may be a direct wireless link, for example, an infrared or laser based communications link. In another embodiment, the wireless link forming the channel 111 may be a point-to-point radio communications link. The vehicle may also use indirect communications, where messages or data from a first vehicle is transmitted to one or more communications receivers and forwarded by the one or more communications receivers to a second vehicle. The communications channel 110 may be a multi-point military radio system, an 802.11x communications network, a satellite communications network, or the like, where the interface 110 is configured for the type of channel 111. In another embodiment, the communications interface 110 may interface to a mesh network. For example, a plurality of convoy vehicles (113i, 113i−1, 113i−2, etc.) may establish a network whereby communications may be sent to any of the convoy vehicles either directly or indirectly via a communications interface 110 another of the plurality of vehicles.

The CPU 102 also may interface with an actuator interface 112. The actuator interface may supply control signals to directly or indirectly control convoy vehicle devices such as steering actuators, throttle actuators, brake actuators, transmission actuators, or any other mobility or auxiliary device actuators.

In some embodiments, the functions of the computing system 100 may be distributed among a plurality of devices that together provide the above-described functions of the computing system 100. In addition, the CPU 102 may be distributed among a plurality of central processing unit modules in communication with each other.

The devices may be distributed across different vehicles 113i, 113i−1, etc. The convoy control system 100 may be implemented in one vehicle, such as a lead vehicle or a command vehicle. In other examples, each of the vehicles 113i, 113i−1, etc. forming the convoy may include a control system like that of system 100. In any event, each of the vehicles 113i, 113i−1, etc. may include sensors, as described herein. The configuration of FIG. 100 also depicts a remote access computer system 115, which represents network devices capable of accessing convoy data and the system 100 for monitoring or control purposes. Such network-enabled devices 115 may include, by way of example, a network-enabled cellular wireless terminal, a phone, a tablet computer, a desktop computer, a server computer, a cluster of server computers, a personal digital assistant (PDA), a smartphone, a laptop computer, a wearable wireless communication device such as a wearable computer, a portable media player, an e-reader, or other similar devices (not shown). The devices 115 may be for personnel in the field, a centralized command, or otherwise.

Throughout this disclosure, plural instances may implement components, operations, or structures described in a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structure and functionality presented as a single component may be implemented as separate components. These and other variations, modifications, additions, and improvements fall within the scope of the subject matter herein.

Furthermore, the autonomous vehicle convoy may include but is not limited to any combination of unmanned (or manned) vehicle types, including ground vehicles, aerial vehicles, surface vehicles, underwater vehicles, and space vehicles, for example. Moreover, while only a maximum of four convoy vehicles are illustrated in FIGS. 2-4 and 6-7, to simplify and clarify the description, it is understood that any number of convoy vehicles may be used according to the present disclosure.

Additionally, certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be drive by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operation described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware of software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a military facility, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

The performance of certain of the operations may be distributed among the one or more processors, not only residing within a single machine, but deployed across a number of machines. In some example embodiments, the one or more processors or processor-implemented modules may be located in a single geographic location (e.g., within a military facility, an office environment, or as a server farm). In other example embodiments, the one or more processors or processor-implemented modules may be distributed across a number of geographic locations.

Some portions of this specification are presented in terms of algorithms or symbolic representations of operations on data stored as bits of binary digital signal within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-contained sequence of operations or similar processing leading to a desired result. In this context, algorithms, routines, and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” of the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, any reference to “one embodiment” or “an embodiment” or “one example” or “an example” (and plural forms thereof) means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still cooperate or interact with each other. The embodiments are not limited in this context.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not an exclusive or. For example, a condition A or B is satisfied by any one of the following: A is true (or present) and B is false (or not present), A is false (or not present) and B is true (or present), and both A and B are true (or present).

In addition, “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict embodiments of systems and methods for improved position estimation and vehicle control in autonomous multi-vehicle convoys for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for systems and processes for improved position estimation and vehicle control in autonomous multi-vehicle convoys using the principles disclosed herein. Thus, while particular embodiments and applications have been illustrated and described, it is to be understood that the disclosed embodiments are not limited to the precise construction and components disclosed herein. Thus, while particular embodiments and applications have been illustrated and described, it is to be understood that the disclosed embodiments are not limited to the precise construction and components disclosed herein. Various modifications, changes, and variations, which will be apparent to those skilled in the art, may be made in the arrangement, operation, and details of the method and apparatus disclosed herein without departing from the spirit and scope defined in the appended claims.

What is claimed:

1. A computer-implemented method for determining a control sequence for a follower vehicle in a multi-vehicle convoy, the method comprising:
a) receiving, at a convoy control system, a control sequence for a lead vehicle;
b) estimating, at the convoy control system, a vehicle path for the lead vehicle;
c) initializing a current best control sequence equal to the lead vehicle control sequence;
d) forward simulating, at the convoy control system, a vehicle control sequence for the follower vehicle based on the current best vehicle control sequence, generating a forward simulated path;
e) measuring the error between the forward simulated vehicle path and the lead vehicle path;
f) performing a gradient descent operation on the forward simulated vehicle control sequence;
g) analyzing the forward simulated vehicle control sequence for convergence with the lead vehicle path;
if the forward simulated control sequence does not converge with the vehicle path, setting the current best control sequence equal to the forward simulated vehicle control sequence then repeating d), e), f) and g); and
if the forward simulated control sequence does converge with the vehicle path, issuing the forward simulated control sequence to the follower vehicle.

2. The computer-implemented method of claim 1, wherein estimating the lead vehicle path further comprises:
receiving, at a convoy control system, one or more pose sensor readings for the lead vehicle;
loading, at the convoy control system, a vehicle model for the lead vehicle;
using an extended Kalman filter to determine the lead vehicle's current best pose estimate based on the lead vehicle's sensor readings and the vehicle model for the lead vehicle; and
using a fixed-lag Kalman smoother to improve the lead vehicle's position estimate over a previous period of time based on the vehicle model.

3. The computer-implemented method of claim 2, wherein the previous period of time is equal to the convoy length divided by the convoy speed.

4. A vehicle of a multi-vehicle convoy, the vehicle comprising:
a convoy control system having a processor, a memory and a communications interface, wherein the convoy control system configured to
a) receive, at a convoy control system, a control sequence for a lead vehicle;
b) estimate, at the convoy control system, a vehicle path for the lead vehicle;
c) initialize a current best control sequence equal to the lead vehicle control sequence;
d) forward simulate, at the convoy control system, a vehicle control sequence for the follower vehicle based on the current best vehicle control sequence, generating a forward simulated path;
e) measure the error between the forward simulated vehicle path and the lead vehicle path;
f) perform a gradient descent operation on the forward simulated vehicle control sequence;
g) analyze the forward simulated vehicle control sequence for convergence with the lead vehicle path;
if the forward simulated control sequence does not converge with the vehicle path, set the current best control sequence equal to the forward simulated vehicle control sequence then repeating d), e), f) and g); and
if the forward simulated control sequence does converge with the vehicle path, issue the forward simulated control sequence to the follower vehicle.

5. A non-transitory computer-readable storage medium having stored thereon a set of instructions, executable by a processor, for determining a control sequence for a follower vehicle in a multi-vehicle convoy, the instructions comprising:
a) instructions for receiving, at a convoy control system, a control sequence for a lead vehicle;
b) instructions for estimating, at the convoy control system, a vehicle path for the lead vehicle;
c) instructions for initializing a current best control sequence equal to the lead vehicle control sequence;
d) instructions for forward simulating, at the convoy control system, a vehicle control sequence for the follower vehicle based on the current best vehicle control sequence, generating a forward simulated path;
e) instructions for measuring the error between the forward simulated vehicle path and the lead vehicle path;
f) instructions for performing a gradient descent operation on the forward simulated vehicle control sequence;
g) instructions for analyzing the forward simulated vehicle control sequence for convergence with the lead vehicle path;
instructions for, if the forward simulated control sequence does not converge with the vehicle path, setting the current best control sequence equal to the forward simulated vehicle control sequence then repeating d), e), f) and g); and
instructions for, if the forward simulated control sequence does converge with the vehicle path, issuing the forward simulated control sequence to the follower vehicle.
